(19) United States
(12) Patent Application Publication
(10) Pub. No.: US 2019/0251601 A1
(43) Pub. Date: Aug. 15, 2019

(54) ENTITY DETECTION USING MULTI-DIMENSIONAL VECTOR ANALYSIS

(71) Applicant: Google LLC, Mountain View, CA (US)

(72) Inventors: Gavin James, Los Angeles, CA (US); Justin Lewis, Marina del Ray, CA (US)

(73) Assignee: Google LLC, Mountain View, CA (US)

(21) Appl. No.: 16/393,888

(22) Filed: Apr. 24, 2019

Related U.S. Application Data
(63) Continuation of application No. 14/294,909, filed on Jun. 3, 2014.

(51) Int. Cl. G06Q 30/02

(52) U.S. Cl. CPC G06Q 30/0269; G06Q 30/0275

(57) ABSTRACT

The present disclosure is directed to notifying a first entity of an online content platform about second entities. In some implementations, a first entity's online content platform account can be accessed. An algorithm can be applied to data of the account profile to determine a plurality of current second entities related to the first entity. A list of second entities stored prior to the determination can be retrieved from a memory element. The plurality of current second entities can be compared with the retrieved list of second entities to identify a new second entity based on the comparison. A notification can be provided to the first entity indicating an occurrence of the new second entity.

### CROSS-REFERENCE TO RELATED APPLICATIONS

This application claims the benefit under 35 U.S.C. § 120 as a continuation of U.S. patent application Ser. No. 14/294,909, filed Jun. 3, 2014, the disclosure of which is hereby incorporated by reference in its entirety.

### BACKGROUND

Entities, such as companies, businesses or advertisers, may have numerous competitors performing various activities. The competitors may change over time, such as when new companies are formed and begin to compete with the entity. It may be challenging for entities to identify their competitors or activities of their competitors.

### SUMMARY

Systems and methods of the present disclosure are directed to notifying customers of their competitors. The technology can identify new competitors based on activities of competitors and comparing current activities with historical activities. By identifying new competitors and notifying customers of new competitors, the customer may, in some implementations, adjust their marketing strategy. In an illustrative implementation, an advertisement customer may, upon being notified of a new competitor in their market, change their advertisement campaign in an online advertisement platform to, e.g., increase their spend or budget, change their selection criteria, change the content of their advertisements, etc.

At least one aspect of the present disclosure is directed to a method of notifying customers of competitors. In some implementations, the method can include a computing device accessing an account profile of an advertisement customer on an online advertisement platform. The method can include the computing device applying an algorithm to the account profile to determine a plurality of current competitors of the advertisement customer. The method can include the computing device retrieving, from a memory element, a list of competitors stored prior to the determination of the plurality of current competitors. The method can include the computing device comparing the plurality of current competitors with the retrieved list of competitors. The method can include the computing device identifying a new competitor based on the comparison. The method can include the computing device providing a notification to the advertisement customer indicating occurrence of the new competitor.

In some implementations, the method can include the computing device comparing a first activity of the plurality of current competitors with a second activity of the competitors on the retrieved list of competitors. In some implementations, where the retrieved list of competitors includes the new competitor, the method can include the computing device identifying the new competitor based on the second activity being greater than the first activity. In some implementations, the method can include the computing device measuring activity by identifying an event. The event can include at least one of adding a new advertisement campaign, editing an existing advertisement campaign, removing an existing advertisement campaign, broadening the scope of an existing advertisement campaign, narrowing the scope of an existing advertisement campaign, winning a campaign bid, and losing a campaign bid. In some implementations, the event includes a first event and a second event, and the method can include applying a first weight to the first event; applying a second weight to the second event; and measuring the activity based on the first weight of the first event and the second weight of the second event.

In some implementations, the method can include the computing device identifying an advertisement market of the advertisement customer. The method can include the computing device determining the new competitor based on the new competitor winning a bid in the advertisement market.

In some implementations, the notification includes an advertisement category of the new competitor. In some implementations, the notification includes demographic information associated with computing devices displaying an advertisement of the new competitor. In some implementations, the new competitor may not be on the retrieved list of competitors.

At least one aspect is directed to a system for notifying customers of competitors. The system can include a data processing system. In some implementations, the data processing system can include a notification engine, an interface, a memory element, and one or more processors. The memory can store processor-executable instructions. In some implementations, the processor can be configured to access an account profile of an advertisement customer on an online advertisement platform. The processor can be configured to apply an algorithm to the account profile to determine a plurality of current competitors of the advertisement customer. The processor can be configured to retrieve a list of competitors stored prior to the determination of the plurality of current competitors. The processor can be configured to compare the plurality of current competitors with the retrieved list of competitors. The processor can be configured to identify a new competitor based on the comparison. The processor can be configured to provide a notification to the advertisement customer indicating occurrence of the new competitor.

At least one aspect is directed to a computer-readable storage device. The computer readable storage device can include instructions to provide information via a computer network. The instructions can include instructions to access an account profile of an advertisement customer on an online advertisement platform. The instructions can include instructions to apply an algorithm to the account profile to determine a plurality of current competitors of the advertisement customer. The instructions can include instructions to retrieve a list of competitors stored prior to the determination of the plurality of current competitors. The instructions can include instructions to compare the plurality of current competitors with the retrieved list of competitors. The instructions can include instructions to identify a new competitor based on the comparison. The instructions can include instructions to provide a notification to the advertisement customer indicating occurrence of the new competitor.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is an illustration of one implementation of a system to provide notification via a computer network.

FIG. 2 is an illustration of one implementation of vector distance functions used to provide notifications via a computer network.

FIG. 3 is an illustration of one implementation of vector distance functions used to provide notifications via a computer network.

FIG. 4 is an illustration of one implementation of a method of providing notifications via a computer network.

FIG. 5 is a block diagram illustrating a general architecture for a computer system that may be employed to implement various elements of the systems and methods described herein, in accordance with an implementation.

### DETAILED DESCRIPTION

Following below are more detailed descriptions of various concepts related to, and implementations of, methods, apparatuses, and systems for automatic notification to an online advisement customer of new competitors and competitors that became more significant. The various concepts introduced above and discussed in greater detail below may be implemented in any of numerous ways, as the described concepts are not limited to any particular manner of implementation. Examples of specific implementations and applications are provided primarily for illustrative purposes.

Systems, methods and apparatus of the present disclosure provide notifications to customers. The notifications may identify a new competitor of the customer or a change in activity of a competitor (e.g., the competitor may become more or less active, enter a different market, change their marketing strategy or tactics, become more or less successful at reaching end users, etc.). The notifications can identify types of competitors (while masking a competitors identity) in various different platforms including, e.g., an online advertisement platform, social media platform, online video streaming platform, online news aggregator platform, social network platform, or other online platform where competitors may compete with a customer for market share, impressions, clicks, conversions, or access in general. In an illustrative implementation, a data processing system can periodically check for new competitors, which may include (1) new advertising entities that were not competing with a customer in the past or (2) existing advertising entities that were active in an online advertising platform but became more active. The data processing system can then identify the competitor and notify to the customer of the competitor, thus keeping the customer updated about changes in the market place. Further, the data processing system can notify the customer of important events associated with the identified competitors, such as a top competitor making a change to their advertisement campaign that results in 20% more meaningful impressions.

The data processing system can automatically detect competitors and detect new competitors of the customer with minimum or no input from the customer. For instance, in some implementations, the data processing system can dynamically determine advertisement categories according to the customer's profile or customer's activities. The data processing system can then search for competitors based on the determined advertisement categories. Thus, in some implementations, the data processing system can identify competitors without the customer identifying the advertisement categories.

An “online advertiser” or “internet advertiser” refers to a business (typically represented by a domain name, a web address, URL, or a smartphone app) that uses the Internet to deliver promotional marketing messages to consumers. To improve advertisement efficiency, an online advertiser desires to display online advertisements on an online space that is likely visited by potential customers. Online advertisers that target similar consumer groups, accordingly, are likely to compete with each other for the same online space. Such online advertisers, therefore, belong to the same “advertising category” and are “advertisement competitors.”

In some implementations, some or all competitors in a particular advertisement platform can be identified for an advertising customer. When such an identification procedure repeats after a period of time, a comparison of the lists of potential competitors can help determine which of them are new.

Nevertheless, in some implementations, it can be more effective to just identify a finite number of competitors (also referred to as “top competitors”). Such a finite number can be predetermined, either arbitrarily or statistically. Alternatively, a threshold or criterion can be established to filter the list of potential competitors to obtain the top competitors.

The data processing system can identify an advertiser as a competitor to an advertising customer if the advertiser participates in a bid with the customer for particular online space, e.g., a keyword, phrase, term, entity, vertical, category at a particular location, etc. Further, the data processing system may determine that the advertiser is a competitor if the advertiser outbids the customer and wins the bid.

The data processing system can manipulate data about advertising customers to determine competitors. In some implementations, the data processing system plots advertising customers of an advertisement platform on a multidimensional space. Using this multidimensional space, the data processing system can determine that the nearest neighbors of a customer are determined to be the most likely competitors to the customer. In other words, the data processing system can generate a distance matrix using these dimensions to measure the “market similarity” between advertising customers.

In an illustrative implementation, the data processing system can apply one or more functions, techniques, procedures, or algorithms on metrics such as clicks, cost, impressions, conversions, etc. to identify competitors or entities that similar to the customer. The techniques can include vector distance functions such as EXTENDED_JACCARD, DOT_PRODUCT, SUM_OF_MIN, OVERLAP, WEIGHTED_JACCARD and TWO_HOP_PAGERANK. In an illustrative implementations, the data processing system can determine these vector distance functions using the following functions:

$$\begin{matrix}DOT\_PRODUCT & \\ DOT\_PRODUCT: D ( h , d ) = {\sum }_{m ∈ M} {C}_{h} ( m ) \cdot {C}_{d} ( m ) & Equation 1 \\ SUM\_OF \_MIN & \\ SUM\_OF \_MIN : {\sum }_{m ∈ M} min ( {C}_{h} ( m ) , {C}_{d} ( m ) ) & Equation 2 \\ EXTENDED\_JACCARD: & \\ EXTENDED\_JACCARD: \frac{D ( h , d )}{D ( h , h ) + D ( d , d ) - D ( h , d )} & Equation 3 \\ WEIGHTED\_JACCARD: & \\ WEIGHTED\_JACCARD: \frac{{\sum }_{m ∈ M} min ( {C}_{h} ( m ) , {C}_{d} ( m ) )}{{\sum }_{m ∈ M} max ( {C}_{h} ( m ) , {C}_{d} ( m ) )} & Equation 4 \\ OVERLAP & \\ OVERLAP = \frac{{\sum }_{m ∈ M : {C}_{h} ( m ) , {C}_{d} ( m ) > 0 )} {C}_{h} ( m ) + {C}_{d} ( m )}{{\sum }_{m ∈ M} {C}_{h} ( m ) + {\sum }_{m ∈ M} {C}_{d} ( m )} & Equation 5 \\ TWO\_HOP \_PAGERANK : & \\ TWO\_HOP \_PAGERANK : \frac{{\sum }_{m ∈ M} \frac{{C}_{h} ( m ) \cdot {C}_{d} ( m )}{{C}_{m}}}{{\sum }_{m ∈ M} {C}_{h} ( m )} & Equation 6\end{matrix}$$

In some implementations, Cₕ(m) refers to the number of clicks that a customer's advertisement campaign is getting on a market m. In some implementations, Cₕ(m) refers to the cost of a customer's advertisement campaign in a market m. In some implementations, M refers to the overall set of markets under consideration. In some implementations, Cₘ denotes the total number of clicks (or cost) in market m, over all competitors, not just the two under consideration. Similarly, C_{d}(m) refers to the number of clicks or costs associated with a domain of a potential competitor.

When measuring similarity between advertising customers, the data processing system can apply weights to the vector distance functions. The weights can be based on an effectiveness of the vector distance functions or an importance of the vector distance functions. The effectiveness of a vector distance function in identifying competitors can be determined based on experimentation, optimization algorithms, or predetermined. In an illustrative implementation, the data processing system can weight the vector distance functions “TWO_HOP_PAGERANK,” “SUM_OF_MIN” and “DOT-PRODUCT” higher or more heavily as compared to the other three vector distance functions when measuring the similarity between advertising customers.

The data processing system can be configured to periodically identify competitors for a customer. They can then be stored and compared against previous lists of competitors. When the list changes because a new competitor is added to it (or a competitor is replaced) then a notification can be generated and displayed to the customer.

In some implementations, the data processing system may notify a customer about an existing competitor base on a recent event such as, e.g., the existing competitor adding new campaigns, editing existing campaigns (e.g., changing bid, changing user interface), removing existing campaigns, or broadening an existing campaign (e.g., to new keywords or demographics). Events might also include passive actions such as a competitor winning more (or most) impressions in a particular vector (search term/demographic/web location/geolocation).

In some implementations, events associated with a competitor can be aggregated to determine whether the competitor has become more active or less active (e.g., more or less active with respect to a threshold such as an activity threshold). In an illustrative implementation, incremental bid increases can be combined into a single event so that the actual bid delta is represented instead of the most recent bid.

Events can be combined based on their importance or based on the time period they represent. For instance, the data processing system can combine incremental bid events to generate a report or notification for a time period (e.g., provide a single notification or report to a customer that has not been on its advertisement account or looked at competitive reports for a predetermined period of time, such as 1 week, 2 weeks, 3 weeks, etc.). In some implementations, the customer may preset the time period, while in other implementations the data processing system may generate a notification for a time period based on the number of events (e.g., provide a notification for every 10 events, or 20 events, etc.). In some implementations, the notifications for a customer can be aggregated when, for instance, they are of the same event, category, user, or combination thereof.

The data processing system can be further configured to measure the importance of a particular event. In some implementations, the importance of an event can be determined based on a threshold (relative or absolute) with respect to the bid or vector(s). In an illustrative implementation, an event can be identified as important if it generates a certain percentage more meaningful impressions or it has a percentage of increase in bid price. Alternatively, bids can be measured relative to the current customer. That is, events can be deemed critical when the bids exceed the bid in a particular vector of the current customer or an advertiser gains more impressions than the user in a particular vector.

The data processing system can provide notification for presentation on a computing device of an advertisement customer. The notifications can be displayed on a display device of the computing device or coupled with the computing device. The data processing system can push the notifications to the computing device via a network, or the computing device can pull the notifications from the data processing system. In some implementations, the data processing system can periodically provide or transmit the notifications to the computing device via the network.

The notification may include relevant information about the new competitor that can help the advertisement customer adjust their advertisement strategy. In some implementations, the notification may mask the identity of the new competitor (e.g., company or domain name) or the new competitor's advertisement strategy (e.g., advertisement keywords purchased or bid on or purchased or bid on video clips in an online streaming video platform or social media platform, etc.).

For instance, the notification can include the advertisement category or targeted demographic of the new competitor. Advertisement category can be based on classification of an advertisement, and the category does not include information of a specific advertisement which may be not suitable for display due to privacy, regulatory or contractual restrictions. For instance, if a new competitor, which is a new supplier, purchases an advertisement keyword “sushi,” the relevant advertisement category can be Asian food or catering. Accordingly, a notification that shows Asian food or catering will be informative to the advertisement customer.

As another example, the new competitor may have purchased to place advertisement on certain video clips in an online video streamlining platform or web pages in a social network platform. Even if the specific identification of the video or the page is not included in the notification, certain categorization of the video or the page, as well as summary statistics of the visitors to the video or the page, can be valuable to the customer.

Thus, even though the data processing system masks or anonymizes the new competitor's identity and specific advertisement content, the customer may be able to appreciate the relevant advertisement direction a new competitor is taking, or whether the new competitor is attempting to access a different group or location of people. Further, and in some implementations, the data processing system may hide or not provide actual bid values.

The features disclosed herein may be implemented on a smart television module (or connected television module, hybrid television module, etc.), which may include a processing module configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

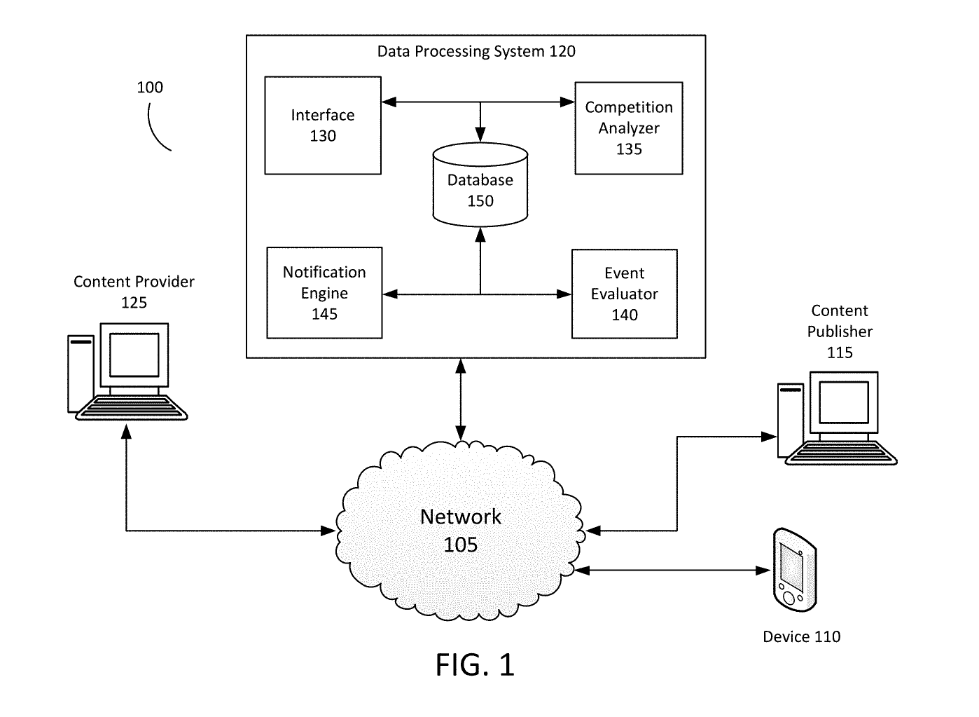

FIG. 1 illustrates one implementation of a system 100 for selecting content via a computer network such as network 105. The system 100 and its components, such as a data processing system 120, may include hardware elements, such as one or more processors, logic devices, or circuits. The network 105 can include computer networks such as the Internet, local, wide, metro, data, or other area networks, intranets, satellite networks, combinations thereof, and other communication networks such as voice or data mobile telephone networks. The network 105 can be used to access information resources such as web pages, web sites, domain names, or uniform resource locators that can be displayed on at least one device 110, such as a laptop, desktop, tablet, personal digital assistant, smart phone, mobile computing devices, mobile telecommunication device, wearable computing device, or portable computer. In one implementation, via the network 105 a user of the device 110 can access web pages provided by at least one content publisher 115 (e.g., a web site operator). In this implementation, a web browser of the device 110 can access a web server of the content publisher 115 to retrieve a web page for display on a monitor of the device 110. The content publisher 115 generally includes an entity that operates the web page. In one implementation, the content publisher 115 includes at least one web page server that communicates with the network 105 to make the web page available to the device 110.

Although FIG. 1 shows a network 105 between the device(s) 110, data processing system 120, content provider 125, and content publisher 115, the device(s) 110, content publisher 115, content provider 125 and data processing system 120 may be on the same network 105. The network 105 can be a local-area network (LAN), such as a company Intranet, a metropolitan area network (MAN), or a wide area network (WAN), such as the Internet or the World Wide Web. In some implementations, there are multiple networks 105 between the devices 110 and the data processing system 120, content provider 125, and content publisher 115. In one of these implementations, the network 105 may be a public network, a private network, or may include combinations of public and private networks.

The network 105 may be any type or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some implementations, the network 105 may include a wireless link, such as an infrared channel or satellite band. The topology of the network 105 may include a bus, star, or ring network topology. The network may include mobile telephone networks using any protocol or protocols used to communicate among mobile devices, including advanced mobile phone protocol (“AMPS”), time division multiple access (“TDMA”), code-division multiple access (“CDMA”), global system for mobile communication (“GSM”), general packet radio services (“GPRS”) or universal mobile telecommunications system (“UMTS”). In some implementations, different types of data may be transmitted via different protocols. In other implementations, the same types of data may be transmitted via different protocols.

The system 100 can include at least one data processing system 120. The data processing system 120 can include at least one logic device such as a computing device having a processor to communicate via the network 105 with the device 110, the content publisher 115, and at least one content provider 125. The data processing system 120 can include at least one server. In one implementation, the data processing system 120 can include a plurality of servers located in at least one data center. In some implementations, the data processing system 120 may include multiple, logically-grouped servers and facilitate distributed computing techniques. In one of these implementations, the logical group of servers may be referred to as a server farm or a machine farm. In another of these implementations, the servers may be geographically dispersed. In other implementations, a machine farm may be administered as a single entity. In still other implementations, the machine farm includes a plurality of machine farms. The servers within each machine farm can be heterogeneous—one or more of the servers or machines can operate according to one type of operating system platform.

In one implementation, servers in the machine farm may be stored in high-density rack systems, along with associated storage systems, and located in an enterprise data center. In this implementation, consolidating the servers in this way may improve system manageability, data security, the physical security of the system, and system performance by locating servers and high performance storage systems on localized high performance networks. Centralizing the servers and storage systems and coupling them with advanced system management tools allows more efficient use of server resources.

The data processing system 120, content provider 125, content publisher 115, and device 110 may be deployed or executed on any type of client or server, or any type and form of computing device, such as a computer, network device or appliance capable of communicating on any type and form of network and performing the operations described herein.

The data processing system can include, e.g., an online advertisement server, social media server, online video streaming system, online news aggregation system, social networking system, or other online platform where competitors may compete with a customer for market share, impressions, clicks, conversions, or access in general. In one illustrative implementation, the data processing system 120 includes a content placement system having at least one server. The data processing system 120 can also include at least one interface 130, at least one competition analyzer 135, at least one event evaluator 140, at least one notification engine 145, and at least one database 150. In one implementation, the data processing system 120 can include a machine learning module such as a logistic regression module or decision tree module. The interface 130, competition analyzer 135, event evaluator 140, notification engine 145, and machine learning module can each include at least one processing unit or other logic device such as programmable logic array engine, or module configured to communicate with the database 150. The interface 130, competition analyzer 135, event evaluator 140, notification engine 145, and machine learning module can be separate components, a single component, or part of the data processing system 120.

In some implementations, the data processing system 120 obtains anonymous computer network activity information associated with a plurality of devices 110. A user of a device 110 can affirmatively authorize the data processing system 120 to obtain network activity information corresponding to the user's device 110. In one implementation, the data processing system 120 can prompt the user of the device 110 for consent to obtain one or more types of network activity information, such as geographic location information. The identity of the user of the device 110 can remain anonymous and the device 110 may be associated with a unique identifier (e.g., a cookie).

For situations in which the systems discussed here collect personal information about users (including, e.g., customers or competitors), or may make use of personal information, the users may be provided with an opportunity to control whether programs or features that may collect personal information (e.g., information about a user's social network, social actions or activities, a user's preferences, or a user's current location), or to control whether or how to receive content from the content server that may be more relevant to the user. In addition, certain data may be treated in one or more ways before it is stored or used, so that certain information about the user is removed when generating parameters (e.g., demographic parameters). In one implementation, a user's identity may be treated so that no identifying information can be determined for the user, or a user's geographic location may be generalized where location information is obtained (such as to a city, ZIP code, or state level), so that a particular location of a user cannot be determined. Thus, the user may have control over how information is collected about the user and used by a content server.

In one implementation, the data processing system 120 receives content or content items from a content provider 125, such as a customer, commercial entity, online retailer, business, advertiser, advertisement customer, competitor, individual or any entity that wants to provide content for display on a device 110 via the computer network 105. The content or content items may include, e.g., text, characters, symbols, images, video, audio, or multimedia content. In one implementation, a content item may include an online advertisement, article, promotion, coupon, or product description.

In one implementation, the data processing system 120 parses a table comprising content group identifiers to compute a mapping to a commercial entity identifier. In one implementation, the data processing system 120 may filter the content group identifiers based on whether the content provider 125 opted in for the systems and methods disclosed herein. The data processing system 120 then queries a content selection data structure extension table with the commercial entity ID to obtain the location extension which contains, e.g., latitude and longitude pairs for the commercial entity's store locations. In one implementation, the data processing system can employ distributed computing on clusters of computers using libraries or programming for processing large data sets.

In some implementations, the data processing system 120 includes an interface 130 designed and constructed to receive a request for content. The interface 130 may be configured to receive a request for content via network 105. The interface 130 can convey information between one or more components of the data processing system or network 105. The interface 130 can be configured to communicate with applications executing on a content provider device 125, content publisher device 115, or device 110. In some implementations, the interface 130 may be configured to convey information via an Application Program Interface (“API”). In some implementations, an application executing on a mobile device may communicate with data processing system 120 via an API configured to communicate with the interface 130.

In some implementations, the data processing system 120 is designed and constructed to select a content item (e.g., an advertisement) based on a search query input via device 110. The data processing system 120 may parse, analyze, match, or otherwise process one or more search terms of the search query to identify one or more candidate content items associated with the search query. In illustrative implementations, the data processing system 120 may receive a search query comprising the term “pizza”. The data processing system 120 may then parse a data structure to identify content items related to pizza, such as advertisements or coupons for pizza restaurants. These content items may be provided by one or more content providers 125. In some implementations, the data processing system 120 may select one or more content items to provide for display on the device based on, e.g., an online auction, advertisement score, keyword score, location, or other criteria. In the online auction, content providers 125 may bid on keywords or other content selection criteria (e.g., location, demographics, topics, etc.). The bids may be associated with a content item. The data processing system may select the content item for display based, at least in part, on the bids associated with the content item (e.g., the content item with the highest bid, with all other factor being equal, may be selected for display on the device 110). In other illustrative implementations, the search query may include a query for a video clip (e.g., in the online media streaming system), a news article (e.g., in the online news aggregation system), or a friend (e.g., in the social networking system).

The data processing system 120 may provide the content item to the web page for display in response to receiving a request for content from a computing device such as, e.g., device 110. In some implementations, the data processing system 120 receives the request via an application executing on the device 110. In some implementations, a mobile application executing on a mobile device (e.g., smart phone or tablet) may make a request for content. In some implementations, a web page may request content from the data processing system 120 responsive to a user of a device 110 visiting the web page. In some implementations, the request for content may be for an online video streaming platform, a social media platform, a social network, computer game, video game, electronic document, banner, etc. In an illustrative implementation, the request for content may be for an item of content to be inserted in a video clip, overlaid on a video clip, displayed in a popup window associated with a video clip, or otherwise displayed before, during or after the video clip. In some implementations, the data processing system 120 may receive a request for content via a search engine and responsive to a user of a device 110 entering a search query.

In an illustrative implementation, the data processing system 120 can receive a search query for “coffee shops” via a device 110. The search query may be input into a search engine accessed via the device 110. The data processing system 120 can receive a request for a content item for display on the device 110. The data processing system 120 may further receive information related to the search query (e.g., keywords, terms, topics) or the search query itself. In some implementations, the request for content items may be a request for content items that are provided for display on a device alongside search results. In some implementations, the request for content items may be a request for content items that are to be displayed on a web page of a web publisher.

In some implementations, the request for content includes information that can facilitate content selection. In some implementations, the data processing system 120 may request information from the device 110 to facilitate identifying content or selecting content. The data processing system 120 may request or obtain information responsive to receiving a request for content from the device 110. The information may include information about displaying the content on the device 110 (e.g., a content slot size or position) or available resources of device 110 to display or otherwise manipulate the content.

In some implementations, the interface 130 receives information associated with a search query which was input into a device. The information may include keywords, terms, concepts of the search query, or the search query itself. In some implementations, the interface 130 receives the information related to the search query via network 105.

Responsive to a request for content from a content publisher 115 (e.g., a search engine provider, web page operator), the data processing system 120 provides a content item for display (or other presentation) with a web page on a device 110. A user of the device 110 may view the content item (e.g., an impression) or may click on or select the content item (e.g., a click). In one implementation, an indication of interest in the content item may include a click, selection, mouse over, finger gesture, shake motion, voice command, tap, or another indication that indicates interest in the content item. In some implementations, the indication of user interaction may include the user using the content item (e.g., a coupon) to make a purchase at a redemption location.

In some implementations, the data processing system 120 can be designed and constructed to provide notifications to a customer (e.g., an advertisement customer of an online advertisement platform, a customer of an online video streaming platform, social media platform, social network, news aggregation site, etc.) about their competitors. The data processing system 120 may include a competition analyzer 135 designed and constructed to identify competitors of a customer. The customer may refer to a user of the data processing system, such as an online advertiser (e.g., content provider 125). In some implementations, the customer may refer to a third-party user of the data processing system 120 that may be associated with the advertising customer or content provider 125. The competition analyzer 135 can be configured to apply various techniques to identify competitors of the customer. The competition analyzer 135 may identify competitors in real-time, a periodic basis, or upon request. In some implementations, the competition analyzer 135 may identify competitors responsive to receiving data about potential competitors or responsive to the customer taking an action (or receiving information about the action). In an illustrative implementation, the competition analyzer 135 may be configured to identify potential competitors of the customer responsive to the customer adding, modifying or removing an advertisement campaign, changing content selection criteria associated with an advertisement campaign (e.g., adding/removing keywords, bid amounts, geographic location selection criteria, demographic selection criteria, etc.). In some implementations, the competition analyzer 135 can be configured to identify competitors of the customer responsive to determining that the customer's advertisement metrics (such as impression rate, click through rate, conversion rate, cost per click, etc.) is sub-optimal (e.g., decreased or increased by a threshold amount within a certain time period).

In some implementations, the competition analyzer 135 can identify competitors using information associated with the customer (e.g., content provider 125). In some implementations, the competition analyzer 135 can identify competitors by measuring a vector distance between the customer and potential competitors. The dimensions of the vectors may be referred to as “nano-markets”, where each dimension may represent information such as a query string, day, geographic location, or platform (or a combination of one or more information). Each advertiser in a market may be weighted using metrics such as impressions, clicks, cost, etc. The competition analyzer 135 may then apply one or more techniques or vector functions to determine the distance between the potential competitors and the customer. In some implementations, the competition analyzer 135 can apply the vector functions identified in Equations 1-6 to determine the vector distance. In Equations 1-6, m refers to a nano-market such as search query string, day, time of day (e.g., time range or morning, afternoon, evening, night), geographic location (e.g., geographic coordinates such as latitude and longitude), geographic area (e.g., country, state, city, town, county, geographic tiles), platform (e.g., operating systems, mobile operating system, desktop operating system), device type (e.g., mobile device, desktop device, tablet, smartphone, mobile telecommunications device, watch, smart watch, notebook computer), web browser, etc. In Equations 1-6, M refers to the overall set of nano-markets under consideration. The identifier h used in Equations 1-6 may refer to information about the customer for whom the data processing system 120 is identifying competitors. Further, the identifier d used in the Equations 1-6 may refer to the domain associated with a potential competitor (e.g., www DOT example DOT com).

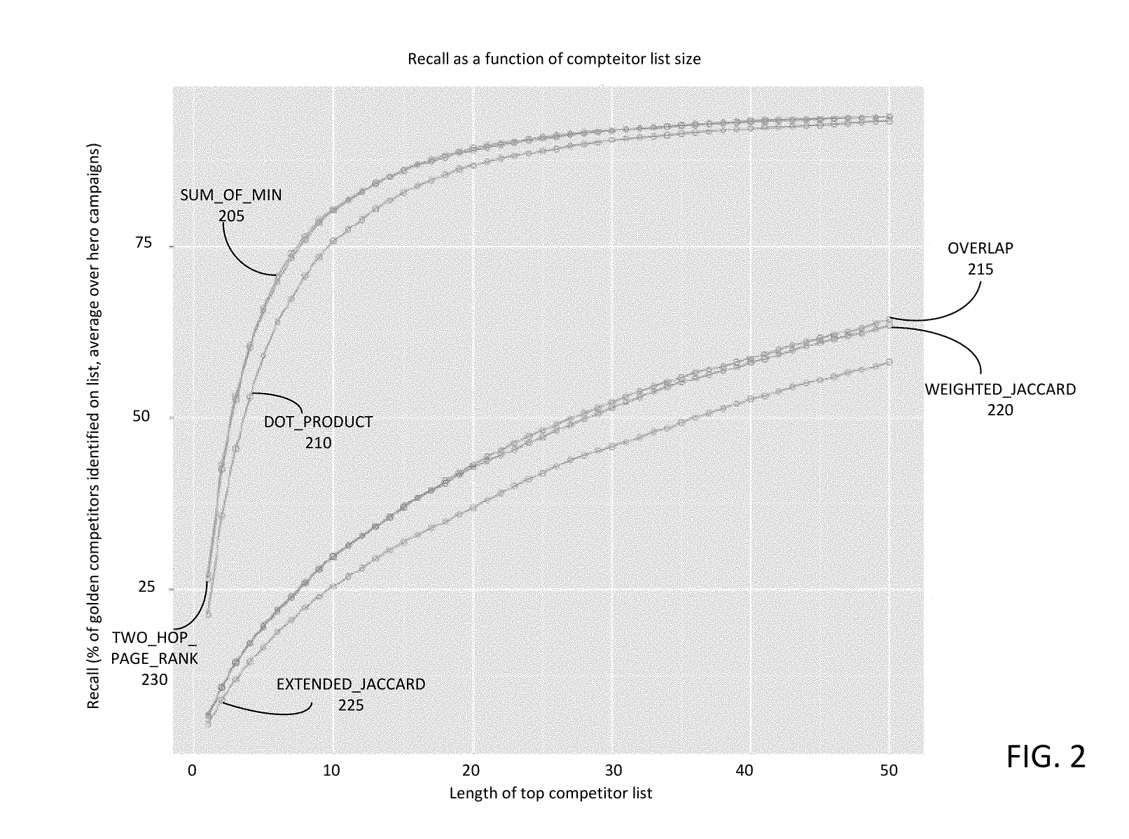

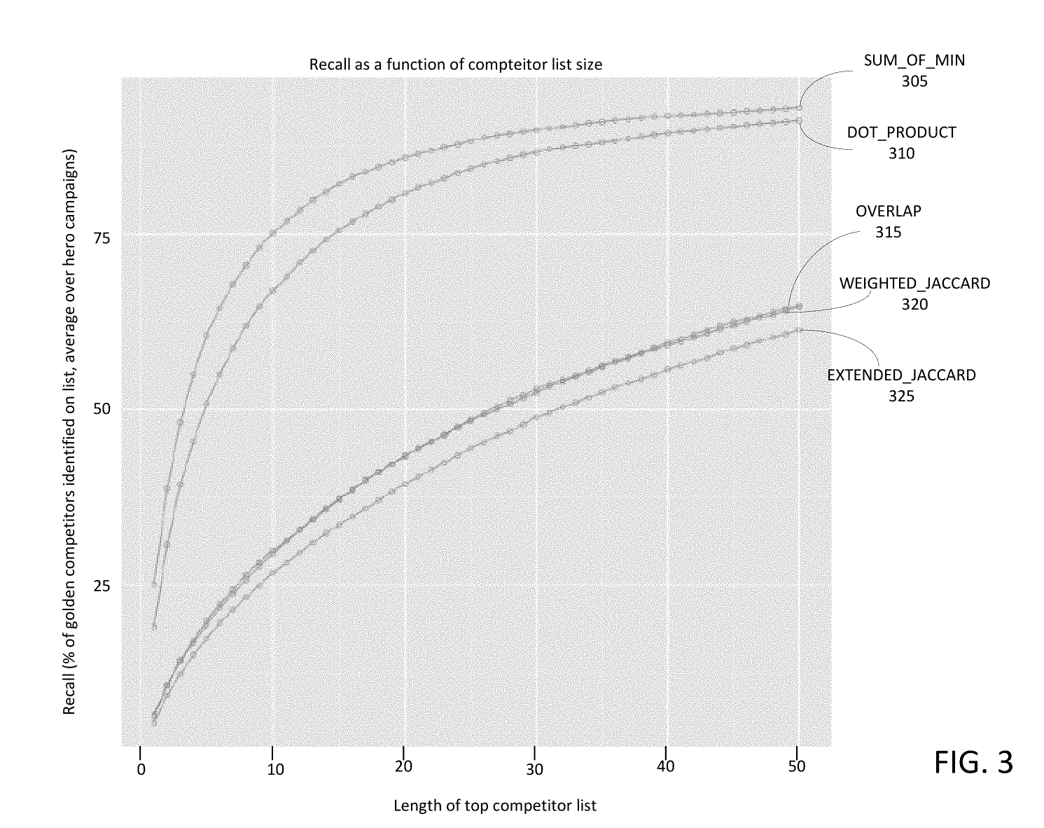

FIGS. 2 and 3 provide a graphical illustration of the effectiveness of Equations 1-6 using the metrics clicks and cost, respectively. One or more of Equations 1-6 is plotted with respect to known competitor information to determine whether Equations 1-6 identify a sufficient number of competitors. In this illustration, the known competitor information is obtained from bid-to-beat data provided by advertisers. Advertisers may provide, for an advertisement campaign, a bid amount to beat a domain (e.g., a competitor) during a time period. These domains represent perceived competitors of the advertiser. The bid amount may be a percentage increase in bid amount or an absolute increase in bid amount. If one or more of Equations 1-6 can reliably or accurately identify a sufficient number of competitors with respect to the bid-to-beat data, then the data processing system 120 can dynamically and automatically identify additional competitors using Equations 1-6 without having to rely on data provided by advertisers.

FIG. 2 illustrates the recall as a function of competitor list size using clicks for each of Equations 1-6 as follows: SUM_OF_MIN 205, DOT_PRODUCT 210, OVERLAP 215, WEIGHTED_JACCARD 220, EXTENDED_JACCARD 225, and TWO_HOP_PAGE_RANK 230. The y-axis represents the recall for the ranking algorithm as the fraction of the domains identified via bid-to-beat data provided by advertisers that were found within the first k competitors using one of the Equations 1-6. To illustrate, if the bid-to-beat data identified competitors foo.com and bar.com, and the Equations 1-6 ranked the competitors as (1) rick.com, (2) bar.com, (3) springfield.com, (4) foo.com, then the recall at 1 is 0%, the recall at 2 is 50%, the recall at 3 is 50%, and the recall at 4 is 100% (further, the recall at 5 would also be considered to be 100%). For each of Equations 1-6 illustrated in FIG. 2, the data is aggregated across campaigns, taking the average recall at ranking indices 1 . . . n in order to compare algorithms. As a result, if the data processing system 120 applies a certain algorithm to output the top N competitors, then it is estimated that this would output on average X % of the competitors identified via the bid-to-beat data provided by advertisers.

As shown in FIG. 2, using clicks as the metric, the TWO_HOP_PAGE_RANK 230, SUM_OF_MIN 205, and DOT_PRODUCT 210 equations perform better than the other three equations because they identify a greater percentage of competitors (e.g., have a higher recall value).

As shown in FIG. 3, using cost as the metric, the SUM_OF_MIN 305 and DOT_PRODUCT 310 equations produce better results than OVERLAP 315, WEIGHTED_JACCARD 320 and EXTENDED_JACCARD 325. However, FIG. 3 illustrates that using cost as the metric may not produce as strong results as clicks as shown in FIG. 2 because all Equations 1-6 perform better with clicks is the metric. Thus, TWO_HOP_PAGE_RANK 230, SUM_OF_MIN 205, and DOT_PRODUCT 210 equations may be effective at identifying competitor domains that customers or advertising campaigns regard as competitors that they would like to outperform.

In some implementations, the competition analyzer 135 may use only one equation to identify competitors (e.g., Equation 2: SUM_OF_MIN). In some implementations, the competition analyzer 135 may use more than one equation to identify competitors (e.g., generate a list of potential competitors using multiple Equations, and identifying competitors as those potential competitors that are identified as being the top N competitor on both lists). Upon identifying competitors using one or more of Equations 1-6, the competition analyzer 135 may store the data in database 150, or provide the data to one or more modules or engines of the data processing system 120.

In some implementations, the data processing system 120 includes an event evaluator 140 designed and constructed to identify and evaluate events associated with identified competitors (e.g., competitors identified via the competition analyzer 135). The event evaluator 140 may retrieve the list of identified competitors stored in the database 150 by the competition analyzer 135, or may receive this information from the competition analyzer 135. The event evaluator 140 can identify actions carried out by these identified competitors or the customer to identify events. In an illustrative implementation, an action may refer to a user of the data processing system 120 adding a new advertisement campaign via interface 130 of the data processing, and the event may refer to the addition of the new advertisement campaign by the user. The events can be associated with information about the event such as a description, time stamp, user identifier (e.g., competitor identifier such as a unique anonymous identifier), geographic location, etc. Events may include, e.g., the addition of a new advertisement campaign, editing an existing advertisement campaign (e.g., changing a bid, changing user interface, changing content selection criteria such as keywords, phrases, entities, demographics, location, device type, etc.), removing an existing advertisement campaign, broadening an existing advertisement campaign (adding new keywords or demographics). Events may include passive actions such as a competitor winning more (or the most) impressions in a vector dimension or nano-market (search term, demographic, web location, geographic location, etc.).

In some implementations, the database 150 can store event data such as actions taken by users of the online advertising platform or passive actions. The event evaluator 140 can access the database 150 storing these events. In some implementations, the event data or actions may be received by the data processing system via a data feed (e.g., streaming data, an RSS data feed, dynamic real-time data feed).

In some implementations, the data processing system 120 identifies events based on the actions. In some implementations, the event evaluator 140 can be further configured to aggregate or combine the identified events (e.g., via an event aggregator). The event evaluator 140 may combine events based on a time period (e.g., events falling within a predetermined or dynamically determined time period), category, competitor identifier, type of event, importance, activity type, etc. The event evaluator 140 may aggregate or combine events in situations in which the events may be too granular to make a significant impact individually, but the events may be important in the aggregate or signify an important trend or pattern. In an illustrative implementation, the event evaluator 140 may combine incremental bid increases made by a competitor into a single event so that the combined bid delta is represented instead of the most recent incremental bid. In another illustrative implementation, the event evaluator 140 may aggregate events or reports for a user (e.g., an online advertisement customer) that has not accessed their online account for a period of time (e.g., three weeks) or otherwise accessed or viewed their competitor reports for the time period. In this situation, the event aggregator may combine incremental bid events to represent changes for the last three instead of syndicating only the most recent bid change, even though the last bid change alone may be significant.

The event evaluator 140 can be designed and constructed to determine the importance of the identified or aggregated events. The event evaluator 140 can measure events using various techniques. In some implementations, the event evaluator 140 may determine the importance of an event by comparing the event with a threshold (relative or absolute) based on a bid or a vector function. The event evaluator 140 may determine an event to be important if the event generates more meaningful impressions than a threshold (e.g., a percentage of more meaningful impressions such as 5%, 10%, 15%, 20%, 50% 75%, 100%, etc.), or the event is an increase in bid price by a threshold (e.g., a percentage increase in bid price or an absolute increase in bid price). In an illustrative implementation, the event evaluator 140 may determine that an identified event (e.g., a change to a content selection criteria such as a keyword of an advertisement campaign) is important if the event resulted in 5% more meaningful impressions (e.g., the impression resulted in a click or a conversion, or the impression was viewed for more than a certain number of seconds or minutes).

In some implementations, the event evaluator 140 can determine whether an event is important by measuring bids relative to the advertising customer. Events may be deemed important when the bids exceed the bid in a particular vector dimension or nano-market of the advertising customer, or the potential competitor gains more impressions than the customer in a particular vector.

In some implementation, the event evaluator 140 weights events based on importance. The event evaluator 140 may determine weights using a machine learning mechanism such as a logistic regression analysis or other regression analysis. The event evaluator 140 may use the logistic regression model to determine that types of events (e.g., adding a new advertisement campaign, editing an existing advertisement campaign, removing an existing advertisement campaign, broadening the scope of an existing advertisement campaign, narrowing the scope of an existing advertisement campaign, winning a campaign bid, or losing a campaign bid) are more or less significant, and weight those events accordingly. In some implementations, the weights may be based on the effect of the event, such the event improving a competitor's click through rate, number of meaningful impressions, winning bids, conversion rate, etc. In an illustrative implementation, the data processing system 120 may determine that an event is important and provide a notification if a competitor broadens the scope of their advertisement campaign and achieves 5% more meaningful impressions (or any other percentage that indicates a significant event).

The data processing system 120 may include a notification engine 145 designed and constructed to generate and provide notifications to a user device (e.g., a content provider 125 or an advertising customer using device 110). The notification engine 145 can generate a notification based on the arrival of a new competitor or activity from an existing competitor in an existing advertising category. In an illustrative implementation, the notification engine 145 may access a database 150 to retrieve a list of old competitors stored in the database 150. The list of old competitors may refer to a previously identified list of competitors (e.g., a list of competitors generated by the data processing system 120 in the last reporting cycle, 1 day ago, 1 week ago, 2 weeks ago, a month ago, etc.). In some implementations, the previous list of competitors may refer to a list of competitors that, at the time the list was generated, was considered to be a current list of competitors and used to provide a notification. The notification engine 145, having retrieved the previous list of competitors, can compare this list of old competitors with a current, newly generated list of competitors (e.g., generated by the competition analyzer 135). The notification engine 145 can compare the lists of competitors to identify any new competitors. The notification engine 145 can use any technique to identify new competitors including, e.g., a deduplication technique, parsing techniques, comparison techniques, etc. Thus, if the notification engine 145 determines that a competitor on the current list of competitors is not on the retrieved list of old competitors, the notification engine 145 may determine that the competitor is a new competitor, and generate a notification. The notification may indicate, to the customer, that there is a new competitor. The notification may also indicate information associated with the new competitor, such as a category, market, a time stamp indicating when (or based on what data) the competitor was identified as being a new competitor, etc.

In some implementations, the notification engine 145 compares an activity of the competitors on the old list of competitors with an activity of competitors on the new list of competitors. The activity may include an event or action. The notification engine 145 may generate or provide a notification based on the comparison. In an illustrative implementation, a competitor on the old, retrieved list of competitors may not have been active (e.g., winning few bids, having a relatively low number of meaningful impressions, having a constant or stagnant number of impressions, etc.). The notification engine 145 may then determine (e.g., via the event evaluator) that the same competitor now has a relatively higher level of activity (e.g., winning more bids or having a higher number of meaningful impressions). Thus, the notification engine 145 may generate or provide a notification to the customer that indicates that a competitor has an increased activity level. The notification may indicate an advertisement category (e.g., type of advertisement such as video ads, search ads, contextual ads, banner ads, popup ads, above the fold ads), advertisement market (e.g., large entity, mid-size entities, small entities, geographic regions, type of goods, type of services), target audience (e.g., demographics, geographic region), etc.

In some implementations, the notification engine 145 can determine the importance of events and then generate or provide a notification to the customer based on the determination. In some implementation, the notification engine 145 obtains the importance of an event from the event evaluator 140.

In some implementations, the notification engine 145 can provide a notification based on the identified new competitor winning a bid in the advertisement market of the customer. The data processing system 120 can access the account profile of the customer to determine the advertisement market (e.g., based on content selection criteria associated with advertisement campaigns of the customer, domains associated with the account profile or customer, categories provided by the customer, company information of the customer, or other information provided by the customer that indicates an advertisement market). The data processing system 120 can further obtain the identified list of competitors and determine which of those competitors is in the same advertisement market of the customer. If one of the identified new competitors in the same advertisement market of the customer wins a bid (or a predetermined absolute or relative threshold number of bids) in the advertisement market, then the notification engine 145 may, responsive to detecting the winning bid, provide an indication of new competitor to the customer. The notification may not include information that identifies the competitor, but may, instead, include general information associated with the competitor, such as the advertisement market, category of the competitor, type of event that triggered the notification, etc.

In some implementations, the notification engine 145 may push notifications to the content provider 125 in real-time (e.g., upon generating a notification, identifying a new competitor or an important event of a competitor). In some implementations, the notification engine may provide notifications to the content provider 125 based on a time period (e.g., periodically, daily, weekly, bi-weekly, monthly or some other time period). In some implementations, the notification engine 145 can be configured to provide notifications to the content provider 125 responsive to receiving a request for notifications, such as a request for notifications from the content provider 125.

The notification engine 145 can generate various types of notifications. The notifications may be provided via an electronic mail, text message, SMS message, notification via an application executing on computing device of the customer (e.g., content provider 125), physical mail (e.g., a monthly or quarterly report), audio notification. In some implementations, the notification may be provided responsive to a customer logging into the data processing system or accessing their account via a web browser or other application. In some implementations, the notification engine 145 can generate a report that includes information about competitors. The report may not include identifying information about the competitor, but may instead include general information about competitors, such as a category, type of competitor, vertical, etc. In some implementations, the notification engine 145 may indicate, e.g., via the report, that the competitor is a new competitor (e.g., based on comparing the competitor with an old or previous list of competitors where the new competitor is not on the list). In some implementations, the notification engine 145 may indicate that the competitor is an old competitor that is associated with an important event (e.g., increased bid amounts, new advertisement campaign, etc.).

In some implementations, the notification engine 145 may provide additional information about the competitor, such as event information associated with the competitor. The event information may indicate that the competitor has changed an aspect of their advertisement campaign or strategy. In some implementations, the information may indicate passive event information associate with the competitor, such as an increase in meaningful impressions of content items associated with the competitor.

In some implementations, the notification engine 145 may generate a report in the form of a spreadsheet that lists the competitors in rows and provides information associated with the competitors in corresponding columns. In some implementations, the notification engine 145 may provide the information via an interactive graphical user interface, such as via interface 130. The interactive graphical information may allow a user of the data processing system 120 to manipulate the display, report or information to facilitate improving their advertisement campaign. In an illustrative implementation, the customer may view a list of competitors and request additional information about one or more competitors. The additional information may indicate why the data processing system 120 identified the competitor as a new competitor (e.g., an event associated with the competitor). By using the graphical user interface, the customer may take actions to change their advertising strategy or tactics in order to improve their advertising campaign or better compete with the competitor. In an illustrative implementation, the data processing system 120 may indicate that the new competitor is associated with an advertisement having an increased number of meaningful impressions. The customer, based on this information, may choose to increase their bid amount of content items that are in the same category as the competitor.

In some implementations, the notification engine 145 may aggregate a set of notifications. The notification engine 145 may aggregate notifications based on a characteristic. The notification engine 145 may aggregate notifications based on the type of event, category, competitor, customer, time period, importance, or combination thereof.

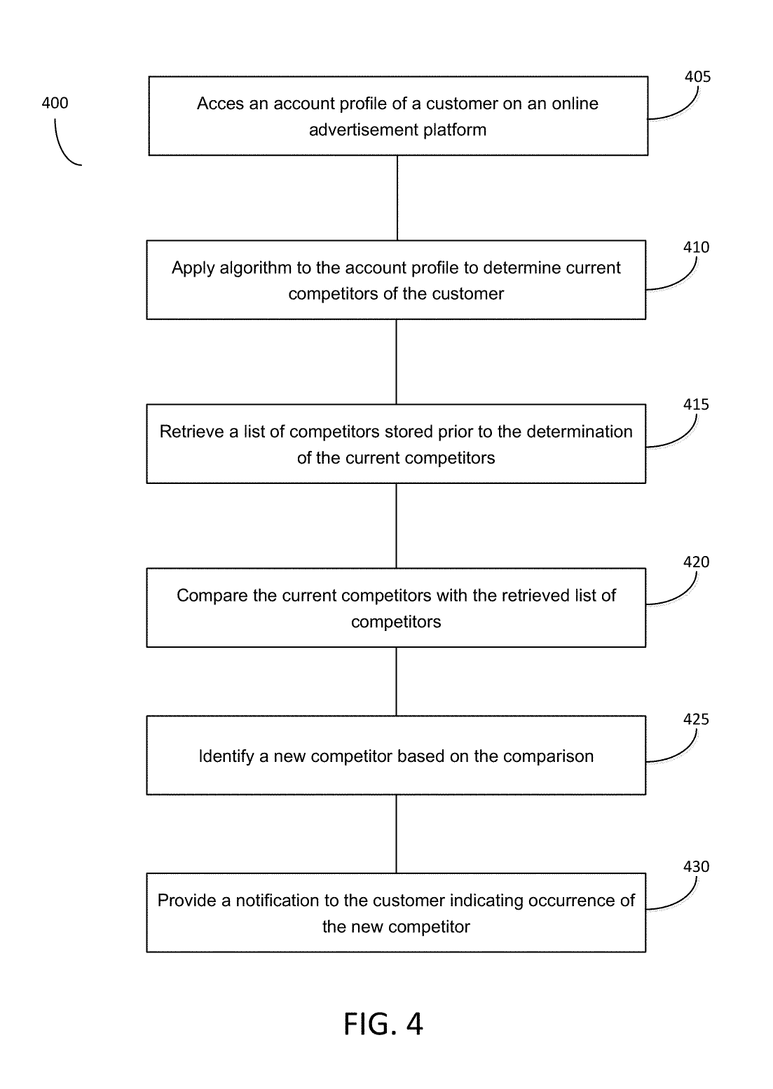

FIG. 4 is an illustration of one implementation of a method of providing notifications via a computer network. In brief overview, at step 405, the method includes accessing an account profile of a customer on an online advertisement platform. At step 410, the method includes applying an algorithm to the account profile to determine current competitors of the customers. At step 415, the method includes retrieving a list of competitors stored prior to the determination of the current competitors. At step 420, the method includes comparing the current competitors with the retrieved list of competitors. At step 425, the method includes identifying a new competitor based on the comparison. At step 430, the method includes providing a notification of the customer indicating an occurrence of the new competitor.

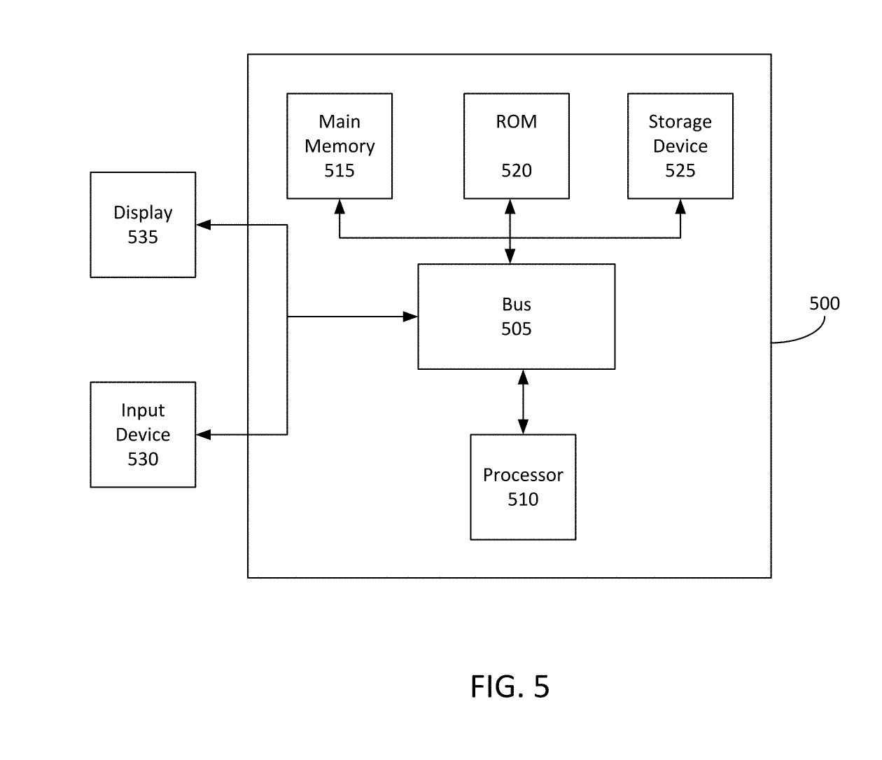

The method including steps 405-430, can be performed by one or more processors executing on one or more computing devices, data processing systems, or servers. The method performed by data processing system 120 as shown in FIG. 1 or the computing system 500 shown in FIG. 5.

In further detail, and in some implementations, a data processing system accesses an account profile of a customer at step 405. In some implementations, the account profile refers to a profile on an online advertisement platform. In some implementations, the account profile may refer to a customer's profile on an online video platform, social media platform, online news platform, a news aggregator platform, an online social network platform, or any other online platform where competitors may compete with a customer for market share, impressions, clicks, conversions, or access to end users in general.

The account information may include information about the customer that can facilitate identifying competitors of the customer. The information may include, e.g., an advertisement market of the customer, content selection criteria associated with advertisement campaigns of the customer (e.g., keywords, entities, phrases, demographics, geographic locations), types of goods or services associated with or provided by the customer, market, business information of the customer (e.g., profits, revenue, or other metrics indicative of the size of the customer's business), domains of the customer (e.g., web site, web page, home page, or landing pages associated with advertisement groups or advertisement campaigns).

In some implementations, the method may include the data processing system accessing the account profile from a database. In some implementations, the data processing system may receive the account profile via a network. In some implementations, the data processing system may request, from the customer, information from the customer rather than access the account profile. In an illustrative implementation, the data processing system may prompt the user, via a graphical user interface, for information that can facilitate identifying customers. This may be done in addition to, or instead of, accessing the customer's account information. In some implementations, the data processing system may determine that the account profile does not contain sufficient information to identify competitors, or that with additional information, more competitors can be more reliably identified using Equations 1-6. In some implementations, the data processing system may obtain the additional information from a database of the data processing system, or other database accessible via a network. Thus, the data processing system may then prompt the customer for this information.

At step 410, the data processing system (e.g., via a competition analyzer) applies an algorithm to information associated with the customer to determine current competitors of the customer. In some implementations, the data processing system applies one or more algorithms. The data processing system can apply the algorithm to the account profile as well as any additional information received from the customer that may facilitate identifying customers. The data processing system can apply one or more of Equations 1-6. In some implementations, the data processing system may determine to apply one or more equations based on the account profile. In some implementations, the data processing system may apply the top ranking algorithm, such as a SUM_OF_MIN vector distance equation.

At step 415, the method includes the data processing system retrieving a list of competitors stored prior to the determination of the current competitors. This retrieved list of previous competitors may have been generated by the data processing system in the past using, e.g., one or more of Equations 1-6. In some implementations, the previous list of competitors may have been generated using other techniques, such as a list of competitors based on bid-to-beat information obtained from customers, or some other previously determined list of competitors.

At step 420, the method includes the data processing system (e.g., via a notification engine) comparing the current competitors with the retrieved list of competitors. In some implementations, the data processing system can compare activity information associated with the current competitors with activity information associated with the retrieved list of competitors. The data processing system can identify new competitors based on the comparison, or may identify changed activities of competitors based on the comparison. In an illustrative implementation, the data processing system can determine, based on the comparison, that a competitor on current list was also on the retrieved list, but has an increase in activity (e.g., increased number of won bids in an advertisement market of the customer). Thus, the data processing system may determine this competitor to be a new competitor, even though the competitor may not have been previously considered to be a significant competitor.

At step 425, the method includes the data processing system identifying a new competitor based on the comparison. The new competitor may be the competitor that exists on the current competitor list but not on the retrieved list of old competitors. In some implementations, the retrieved list of old competitors may include all competitors that were identified as competitors at a previous time, even if those entities were not currently considered competitors due to minimal activity. The retrieved list of old competitors may include information about the activity level of the old competitors, which can be used to facilitate identifying new competitors or old weak competitors that are not stronger competitors.

In some implementations, the method includes the data processing system identifying events (e.g., via an event evaluator) associated with competitors on the current list or the retrieved list. The data processing system can aggregate these events, evaluate these events, or otherwise process these events to generate notifications. In some implementations, the data processing system can include information about events along with the notifications, or generate notifications responsive to events. In some implementations, the data processing system can aggregate types of events together, or aggregate events occurring during a time period, and provided the aggregated information to the customer.

At step 425, the data processing system (e.g., via a notification engine) can generate a notification based on identifying the new competitor. The notification may be provided via network. The notification may be provided via a text message, electronic mail, pop-up window, prompt, an application program executing on a device of the customer (e.g., content provider device). In some implementations, the notification can be provider to the customer when the customer logs in to their account, or otherwise accesses a graphical user interface of a data processing system or notification engine.

FIG. 5 is a block diagram of a computing system 500 in accordance with an illustrative implementation. The computing system or computing device 500 can be used to implement the system 100, content provider 125, device 110, content publisher 115, data processing system 120, interface 130, event evaluator 140, event evaluator 140, notification engine 145, and machine learning module. The computing system 500 includes a bus 505 or other communication component for communicating information and a processor 510 or processing circuit coupled to the bus 505 for processing information. The computing system 500 can also include one or more processors 510 or processing circuits coupled to the bus for processing information. The computing system 500 also includes main memory 515, such as a random access memory (RAM) or other dynamic storage device, coupled to the bus 505 for storing information, and instructions to be executed by the processor 510. Main memory 515 can also be used for storing position information, temporary variables, or other intermediate information during execution of instructions by the processor 510. The computing system 500 may further include a read only memory (ROM) 520 or other static storage device coupled to the bus 505 for storing static information and instructions for the processor 510. A storage device 525, such as a solid state device, magnetic disk or optical disk, is coupled to the bus 505 for persistently storing information and instructions.

The computing system 500 may be coupled via the bus 505 to a display 535, such as a liquid crystal display, or active matrix display, for displaying information to a user. An input device 530, such as a keyboard including alphanumeric and other keys, may be coupled to the bus 505 for communicating information and command selections to the processor 510. In another implementation, the input device 530 has a touch screen display 535. The input device 530 can include a cursor control, such as a mouse, a trackball, or cursor direction keys, for communicating direction information and command selections to the processor 510 and for controlling cursor movement on the display 535.

According to various implementations, the processes described herein can be implemented by the computing system 500 in response to the processor 510 executing an arrangement of instructions contained in main memory 515. Such instructions can be read into main memory 515 from another computer-readable medium, such as the storage device 525. Execution of the arrangement of instructions contained in main memory 515 causes the computing system 500 to perform the illustrative processes described herein. One or more processors in a multi-processing arrangement may also be employed to execute the instructions contained in main memory 515. In alternative implementations, hard-wired circuitry may be used in place of or in combination with software instructions to effect illustrative implementations. Thus, implementations are not limited to any specific combination of hardware circuitry and software.

Although a computing system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Implementations of the subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, i.e., one or more circuits of computer program instructions, encoded on one or more computer storage media for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices).

The operations described in this specification can be performed by a data processing apparatus on data stored on one or more computer-readable storage devices or received from other sources.

The term “data processing apparatus” or “computing device” encompasses various apparatuses, devices, and machines for processing data, including without limitation a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a circuit, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more circuits, sub programs, or portions of code). A computer program can be deployed to be executed on one computer or on multiple computers that are located at one site or distributed across multiple sites and interconnected by a communication network.

Processors suitable for the execution of a computer program include, without limitation, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including without limitation semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; in most implementations, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products.

References to “or” may be construed as inclusive so that any terms described using “or” may indicate any of a single, more than one, and all of the described terms.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. For example, the notifications can be associated with any program capable of generating and providing notifications for display. Although the examples provided herein relate to an advertising program, the systems and methods described herein can be applied to any program in any vertical in which notifications generated by a plurality of different notification generation systems are provided for display on a single user interface. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A method, comprising:
accessing, by a computing device including one or more processors, an account profile of a first entity on an online content distribution platform;
determining, by the computing device, from the account profile, content distribution parameter data of the first entity to identify one or more second entities related to the first entity, the content distribution parameter data including content selection dimensions according to which content items of the first entity are selected for display responsive to content requests;
generating, by the computing device, for the first entity, a multi-dimensional vector comprising values for a plurality of sub-vectors using the retrieved content distribution parameter data, each sub-vector corresponding to a respective content selection dimension of the plurality of content selection dimensions, wherein the values include a value for a respective sub-vector of the plurality of sub-vectors that is based on a performance of content items selected based on the content selection dimension corresponding to the respective sub-vector;
determining, by the computing device, for each of a plurality of candidate second entities, respective content distribution parameter data from a respective account profile of the candidate second entity;
generating, by the computing device, for each of the plurality of candidate second entities, a respective multi-dimensional vector comprising values for a plurality of sub-vectors using the determined respective content distribution parameter data corresponding to the respective account profile of the candidate second entity;
determining, by the computing device for each candidate second entity, a total distance between the multi-dimensional vector of the first entity and the respective multi-dimensional vectors of the plurality of candidate second entities, the distance based on differences in values between the first entity and the candidate second entity for each of the plurality of sub-vectors;
retrieving, by the computing device from a memory element, a list of previously determined second entities related to the first entity;
determining, by the computing device, for at least one previously determined second entity of the list of previously determined second entities, a total distance between the multi-dimensional vector of the first entity and a corresponding multi-dimensional vector of the at least one previously determined second entity, the multi-dimensional vector of the at least one previously determined second entity comprising values for a plurality of sub-vectors using content distribution parameter data of the previously determined second entity;
determining, by the computing device, that the total distance for at least one candidate second entity is less than the total distance for the at least one previously determined second entity; and
identifying, by the computing device, in response to determining that the total distance for at least one candidate second entity is less than the total distance for the at least one previously determined second entity, the at least one candidate second entity as a new second entity; and
transmitting, by the computing device, one or more instructions to a device of the first entity, the instructions configured to cause the device of the first entity to output an identifier identifying the new second entity.

2. The method of claim 1, further comprising generating an updated list of second entities including the new second entity.

3. The method of claim 2, further comprising:
accessing a profile of a second entity of the updated list of second entities including second entity content distribution parameter data;
determining a first set of content selection dimensions for the second entity based on the second entity content distribution parameter data;
updating the second entity content distribution parameter data;
determining a second set of content selection dimensions for the second entity based on the updated second entity content distribution parameter data;
comparing the first set of content selection dimensions to the second set of content selection dimensions;
determining that the first set of content selection dimensions differs from the second set of content selection dimensions based on the comparison; and
providing, by the computing device, a notification to the first entity of an activity of the second entity, the activity being a change of content selection dimensions.

4. The method of claim 2, further comprising:
accessing a profile of a second entity of the updated list of second entities including a set of second entity content distribution parameter data;
accessing an updated set of second entity content distribution parameter data;
comparing a first parameter value of the set of second entity content distribution parameter data to a first parameter value of the updated set of second entity content distribution parameter data to generate a first difference;
comparing the first difference to a first threshold and determining that the first difference equals or exceeds the first threshold; and
providing, by the computing device, a notification to the first entity of an activity of the second entity.

5. The method of claim 4, further comprising:
comparing a second parameter value of the set of second entity content distribution parameter data to a second parameter value of the updated set of second entity content distribution parameter data to generate a second difference;
comparing the second difference to a second threshold and determining that the second difference equals or exceeds the second threshold; and
calculating a total activity by:
applying a first weight to the first activity;
applying a second weight to the second activity; and
calculating the total activity as a weighted average of the first activity and the second activity.

6. The method of claim 3, wherein the notification comprises an indication of a new content selection dimension of the new second entity.

7. The method of claim 1, wherein determining a total distance between the multi-dimensional vector of the online content provider and the multi-dimensional vector of the candidate second entity comprises retrieving, by the computing device from a memory element, a plurality of weights for a plurality of vector distance functions, applying the plurality of vector distance functions to the multi-dimensional vector of the first entity and the multi-dimensional vector of the candidate second entity, and aggregating the respective outputs of the vector distance functions based on the respective weight for each vector distance function.

8. A system, comprising:
a data processing system having a notification engine, an interface, a memory element storing processor-executable instructions, and one or more processors configured to:
access an account profile of a first entity on an online content distribution platform;
determine, from the account profile, content distribution parameter data of the first entity to identify one or more second entities related to the first entity, the content distribution parameter data including content selection dimensions according to which content items of the first entity are selected for display responsive to content requests;
generate, for the first entity, a multi-dimensional vector comprising values for a plurality of sub-vectors using the retrieved content distribution parameter data, each sub-vector corresponding to a respective content selection dimension of the plurality of content selection dimensions, wherein the values include a value for a respective sub-vector of the plurality of sub-vectors that is based on a performance of content items selected based on the content selection dimension corresponding to the respective sub-vector;
determine, for each of a plurality of candidate second entities, respective content distribution parameter data from a respective account profile of the candidate second entity;
generate, for each of the plurality of candidate second entities, a respective multi-dimensional vector comprising values for a plurality of sub-vectors using the determined respective content distribution parameter data corresponding to the respective account profile of the candidate second entity;
determine, for each candidate second entity, a total distance between the multi-dimensional vector of the first entity and the respective multi-dimensional vectors of the plurality of candidate second entities, the distance based on differences in values between the first entity and the candidate second entity for each of the plurality of sub-vectors;
retrieve a list of previously determined second entities related to the first entity;
determine, for at least one previously determined second entity of the list of previously determined second entities, a total distance between the multi-dimensional vector of the first entity and a corresponding multi-dimensional vector of the at least one previously determined second entity, the multi-dimensional vector of the at least one previously determined second entity comprising values for a plurality of sub-vectors using content distribution parameter data of the previously determined second entity;
determine that the total distance for at least one candidate second entity is less than the total distance for the at least one previously determined second entity;
identify, in response to determining that the total distance for at least one candidate second entity is less than the total distance for the at least one previously determined second entity, the at least one candidate second entity as a new second entity; and
transmit one or more instructions to a device of the first entity, the instructions configured to cause the device of the first entity to output an identifier identifying the new second entity.

9. The system of claim 8, wherein the processor is further configured to generate an updated list of second entities including the new second entity.

10. The system of claim 9, wherein the processor is further configured to:
access a profile of a second entity of the updated list of second entities including second entity content distribution parameter data;
determine a first set of content selection dimensions for the second entity based on the second entity content distribution parameter data;
update the second entity content distribution parameter data;
determine a second set of content selection dimensions for the second entity based on the updated second entity content distribution parameter data;
compare the first set of content selection dimensions to the second set of content selection dimensions;
determine that the first set of content selection dimensions differs from the second set of content selection dimensions based on the comparison; and
provide, by the computing device, a notification to the first entity of an activity of the second entity, the activity being a change of content selection dimensions.

11. The system of claim 9, wherein the processor is further configured to:
access a profile of a second entity of the updated list of second entities including a set of second entity content distribution parameter data;
access an updated set of second entity content distribution parameter data;
compare a first parameter value of the set of second entity content distribution parameter data to a first parameter value of the updated set of second entity content distribution parameter data to generate a first difference;
compare the first difference to a first threshold and determining that the first difference equals or exceeds the first threshold; and
provide, by the computing device, a notification to the first entity of an activity of the second entity.

12. The system of claim 11, wherein the processor is further configured to:
compare a second parameter value of the set of second entity content distribution parameter data to a second parameter value of the updated set of second entity content distribution parameter data to generate a second difference;
compare the second difference to a second threshold and determining that the second difference equals or exceeds the second threshold; and
calculate a total activity by:
applying a first weight to the first activity;
applying a second weight to the second activity; and
calculating the total activity as a weighted average of the first activity and the second activity.

13. The system of claim 10, wherein the notification comprises an indication of a new content selection dimension of the new second entity.

14. The system of claim 8, wherein determining a total distance between the multi-dimensional vector of the first entity and the multi-dimensional vector of the candidate second entity comprises retrieving, by the computing device from a memory element, a plurality of weights for a plurality of vector distance functions, applying the plurality of vector distance functions to the multi-dimensional vector of the first entity and the multi-dimensional vector of the candidate second entity, and aggregating the respective outputs of the vector distance functions based on the respective weight for each vector distance function.

15. A computer-readable storage medium having instructions to provide information via a computer network, the instructions comprising instructions to:
access an account profile of a first entity on an online content distribution platform;
determine, from the account profile, content distribution parameter data of the first entity to identify one or more second entities related to the first entity, the content distribution parameter data including content selection dimensions according to which content items of the first entity are selected for display responsive to content requests;
generate, for the first entity, a multi-dimensional vector comprising values for a plurality of sub-vectors using the retrieved content distribution parameter data, each sub-vector corresponding to a respective content selection dimension of the plurality of content selection dimensions, wherein the values include a value for a respective sub-vector of the plurality of sub-vectors that is based on a performance of content items selected based on the content selection dimension corresponding to the respective sub-vector;
determine, for each of a plurality of second entities, respective content distribution parameter data from a respective account profile of the candidate second entity;
generate, for each of the plurality of candidate second entities, a respective multi-dimensional vector comprising values for a plurality of sub-vectors using the determined respective content distribution parameter data corresponding to the respective account profile of the candidate second entity;
determine, for each candidate second entity, a total distance between the multi-dimensional vector of the first entity and the respective multi-dimensional vectors of the plurality of candidate second entities, the distance based on differences in values between the first entity and the candidate second entity for each of the plurality of sub-vectors;
retrieve a list of previously determined second entities related to the first entity;
determine, for at least one previously determined second entity of the list of previously determined second entities, a total distance between the multi-dimensional vector of the first entity and a corresponding multi-dimensional vector of the at least one previously determined second entity, the multi-dimensional vector of the at least one previously determined second entity comprising values for a plurality of sub-vectors using content distribution parameter data of the previously determined second entity;
determine that the total distance for at least one candidate second entity is less than the total distance for the at least one previously determined second entity;
identify, in response to determining that the total distance for at least one candidate second entity is less than the total distance for the at least one previously determined second entity, the at least one candidate second entity as a new second entity; and
transmit one or more instructions to a device of the first entity, the instructions configured to cause the device of the first entity to output an identifier identifying the new second entity.

16. The computer-readable storage medium of claim 15, wherein determining a total distance between the multi-dimensional vector of the first entity and the multi-dimensional vector of the candidate second entity comprises retrieving, by the computing device from a memory element, a plurality of weights for a plurality of vector distance functions, applying the plurality of vector distance functions to the multi-dimensional vector of the first entity and the multi-dimensional vector of the candidate second entity, and aggregating the respective outputs of the vector distance functions based on the respective weight for each vector distance function.

17. The computer-readable storage medium of claim 15, the instructions further comprising instructions to generate an updated list of second entities including the new second entity.

18. The computer-readable storage medium of claim 17, the instructions further comprising instructions to:
access a profile of a second entity of the updated list of second entities including second entity content distribution parameter data;
determine a first set of content selection dimensions for the second entity based on the second entity content distribution parameter data;
update the second entity content distribution parameter data;
determine a second set of content selection dimensions for the second entity based on the updated second entity content distribution parameter data;
compare the first set of content selection dimensions to the second set of content selection dimensions;
determine that the first set of content selection dimensions differs from the second set of content selection dimensions based on the comparison; and
provide, by the computing device, a notification to the online content provider of an activity of the second entity, the activity being a change of content selection dimensions.

19. The computer-readable storage medium of claim 17, the instructions further comprising instructions to:
access a profile of a second entity of the updated list of second entities including a set of entity content distribution parameter data;
access an updated set of second entity content distribution parameter data;
compare a first parameter value of the set of second entity content distribution parameter data to a first parameter value of the updated set of second entity content distribution parameter values to generate a first difference;
compare the first difference to a first threshold and determining that the first difference equals or exceeds the first threshold; and
provide, by the computing device, a notification to the online content provider of an activity of the second entity.

20. The computer-readable storage medium of claim 19, the instructions further comprising instructions to:
compare a second parameter value of the set of second entity content distribution parameter data to a second parameter value of the updated set of second entity content distribution parameter data to generate a second difference;
compare the second difference to a second threshold and determining that the second difference equals or exceeds the second threshold; and
calculate a total activity by:
applying a first weight to the first activity;
applying a second weight to the second activity; and
calculating the total activity as a weighted average of the first activity and the second activity.
